(19) United States
(12) Patent Application Publication
(10) Pub. No.: US 2007/0050374 A1
(43) Pub. Date: Mar. 1, 2007

(54) Novel intelligent search engine

(76) Inventors: Fang Zhao, San Jose, CA (US); Yongan Wu, San Jose, CA (US)

Correspondence Address: FANG ZHAO, 1419 MARIA WAY, SAN JOSE, CA, 95117, US

(21) Appl. No.: 11/217,148

(22) Filed: Sep. 1, 2005

(51) Int. Cl. G06F 17/30

(52) U.S. Cl. 707/10

(57) ABSTRACT

A novel intelligent search engine or website are invented to enhance the web surfing practice. A smart search engine or website comprising of resource database, fuzzy logic analyzer, and question generator which can analyze the user input, comparing with internal criteria, and asking user further questions to narrow down the search. The smart search engine or website can show the desired search result link/links, or show compose customized answer page, or show the desired web page directly. The smart search engine or website can comprise of user database which it uses during the search and modifies during the search.

### BACKGROUND OF THE INVENTION

Currently when someone does a search on the web, he/she typically types in some keywords and tens or millions of search results will show up. Most of them are totally unrelated to what one wants to find. It is a big hassle to really find what one wants. This is just like you going to a department store and trying to find what you want through the millions of stuffs at the department store, only that the internet is a much more gigantic store with too many stuffs that takes almost forever to find what one wanted.

Also when someone visits an internet-store or a website, it takes lots of efforts to find what one is interested, especially if one is not familiar with this particular store or website. It would be great to use some help to expedite this finding process. The typical way is to have a search function for this store or website, however, one faces the similar problem unless one really knows what he is looking for absolute certain as well as how the website is designed and laid out exactly.

This patent is dedicated to the people who want to save both the trouble and time to find exactly what they want without having to dig through millions of unwanted information on the Internet, web store, or website.

### SUMMARY OF THE INVENTION

Intelligent, truly interactive search engine is proposed by the inventor to greatly increase the Internet search speed and accuracy, even though the user knows little about the Internet.

When we surf on the Internet, we type in the searching key words through the user input interface like the keyboard, and very often the search engine gives us thousands of search results from its resource database through the service output interface like display screen, which makes it hard to find the exact information or product we need. Can you choose your favorite from 10,000 candidates? Probably, but it can be very time-consuming and frustrating.

To make this search process dummy proof and easy to use, the search engine/website/web store can design in an internal self guided procedure to greatly smooth out the search process. It can have an intelligent analyzer analyzing the scope and completeness of the user input. It can ask questions before or during the search to know the customer's preference and narrow down the user's true intention. It can try to determine the user's interested category, field, or sub-field. IT can offer greetings and/or small talks to get clue about the user's interests. It can also ask open-ended questions, or clarification questions, or offer multiple suggestions for the user to choose from. It can also provide additional input field for the user to narrow down the inputs while providing the currently most relevant results. The user can answer the question specifically, or give out their preference from some pre-selected choices, or answer yes or no to the questions. It can ask a single question or layered questions to minimize the answers. With the extensive acknowledge about its field and its service, and the power to lead in the aiming, the search engine/store/website can rapidly zoom in to what the user really wants to know. Therefore, it significantly reduced clients' time and efforts. After all, it's easier to choose one product from 5 recommendations rather than 10,000. The service itself knows its content the most, thus can provide the fastest zoom-in route for the user after asking the designed intelligent questions. This will make the Internet really interactive, or truly two-way interaction. The Internet will not be only a dead machine, but an intelligent resource that people can rely on.

The intelligent service can perform the question/answer process through an interactive character, like a cartoon character, a web pet, or any animation figure.

Very often it's difficult to navigate through some websites. When we try to locate just one product or service while shopping on some websites, it's many clicks away and the access route can be very confusion and misleading. It's complex and confusing. Frequently we got lost during the search and had to quit our efforts. As a result, the site lost many sales and opportunities.

The search engine can ask clarification questions to zoom in on exactly what the user wants. So it could dig through the many layers of information and give the right answer or link to the client immediately.

To best serve the user, a website or online store can provide a brief or a detailed tour to the user, introducing the most important links on the page. This can happen automatically with no click from the user. Or it can happen on a single click on a specific button/pattern by the user. Or it can happen on a double click by the user. The tour can be a page-by-page tour, or link-by-link tour, or it can be an audio or video tour.

The website or online store can perform the question/answer, or tour session using a virtual guide, or help, or through a character, like a pin, a cartoon character, a virtual pet, or other animation characters.

The question asked can be text or picture like, it can also be audio or video like so people can see, or listen the question, and then answer in voice, key in or mouse click in.

A user database can be used in all the above intelligent service. The user interface can remember the users' preferences and interests, thus skip oven some questions, and/or ask questions in the specific user's preferred arena, thus give out their destination faster, and give their preferred area priority in the searching results. The user interface can be updated periodically or during the user's every use. The user data can be stored in the user's local computer or on a remote site. The user database can ask the user to provide initial basic information and can also ask the user to update it from time to time.

The service using the intelligent question/answering feature can be an online store, online search engine, company website, organization website, online blog site, and other online service site.

The service using the intelligent question/answering feature can be used on a TV, or a remote controller, or a computer, or a telephone, or a wireless phone, or an automobile control and/or navigation system, or an game module like X-box, play station, or a home entertainment center, or any other programmable chip controlled devices.

### BRIEF DESCRIPTION OF THE DRAWINGS

FIG. 1 is a flow chart for a traditional search engine.

FIG. 2 is a schematic diagram of an illustrative novel search engine or website.

FIG. 3 is another schematic diagram of an illustrative novel search engine or website. A direct like or customized result page can be given as the result of the search.

FIG. 4 is another schematic diagram of an illustrative novel search engine or website using user database.

FIG. 5 is another schematic diagram of an illustrative novel search engine or service site using additional user input field to narrow down the search.

### DETAILED DESCRIPTION OF THE PREFERRED EMBODIMENTS

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

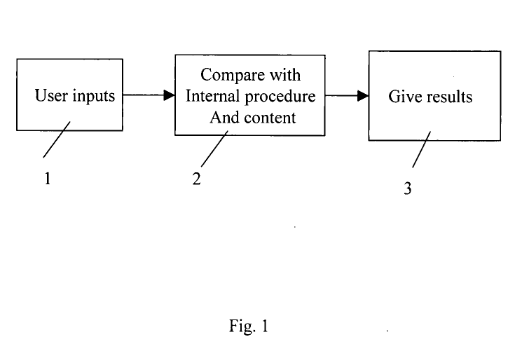

FIG. 1 illustrates the traditional search engine or service site. First user gives inputs 1 to the computer. In step 2 the computer compares the user inputs with its internal procedure and content in its database, and gives the searched results in step 3. In many cases, the results are not what the user really looking for.

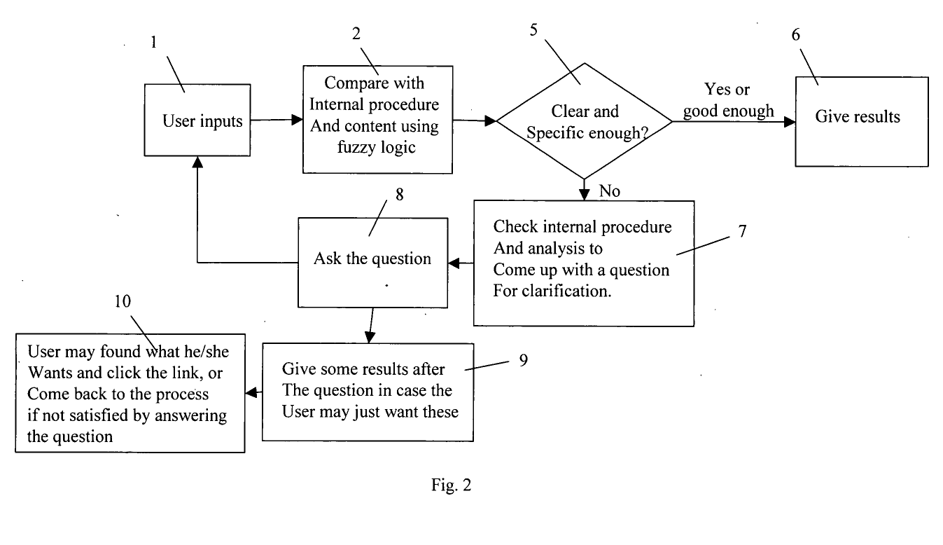

FIG. 2 illustrates an intelligent search engine or service site. In block 1 it takes the user inputs. In block 2 the computer compares the user input with internal procedures and contents using logic or fuzzy logic. Next in block 5 the intelligent search engine analyze logic output value. If it determines that the output value is good enough, it gives the search results out in block 6. If it determines that it could not give good enough answers (with a low logic output value), it can come up with questions following its predetermined internal procedures and analysis. The question can be open ended or close ended, or it can be multiple choices for the user to choose from. Next in block 8 it asks questions for clarifications. The user can choose to answer the question by giving more input and the process goes back to block 1. In the same time asking the question in block 8, in block 9 the search engine can gives some results after the question in case the user may just want one of these results and click it in block 10.

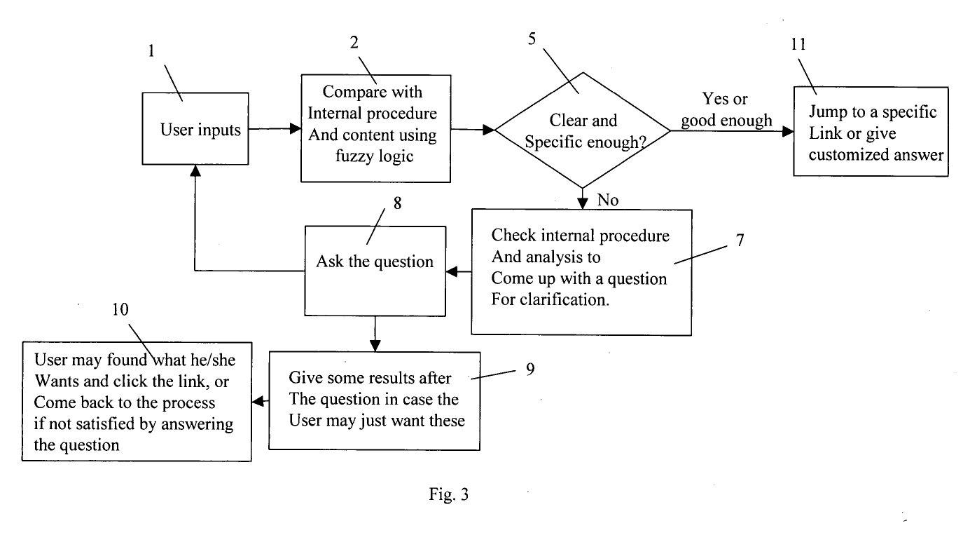

FIG. 3 illustrates a customized intelligent search engine or a service site. It is the same as shown in FIG. 2, except the search engine or website can choose to jump to a specific link or give customized answers in block 11 once it determines that it have clear understandings of the user. It can just to the most relevant links satisfying the user, or give customized results directly addressing the user's need, like a specific made-up page or answers.

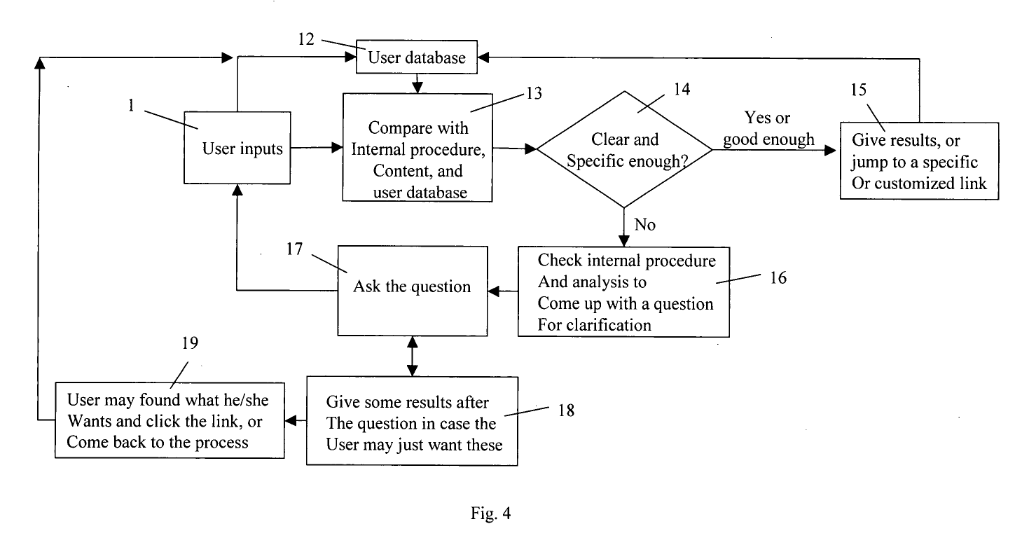

FIG. 4 illustrates an intelligent search engine or service site, which can have a user database 12 in place. The user database 12 can be saved in the user's local machine for privacy or saved in the central office for easy management and control, or both. Once a user inputs a new request 1, the service can compare the request with its internal procedure, content, as well as the specific user's information in the user database in block 13. Next in block 14 if it determines that all these information is clear enough for the service to answer the request, it can provide the answer, or jump to a specific or customized link in block 15. Otherwise, it can come up with a question based on the information it already has to get clarifications on the request in block 16. The question can be open ended or close ended, or it can be multiple choices for the user to choose from. The question are asked in block 17 and the user can choose to answer the question and the whole process repeat with user inputs to block 1. While asking the question, it can also show some best answers based on the currently available information in block 18. The user may find just what he needs and pursue the lead, or come back to the question and answering loop as shown in block 19. All the user related information in the interaction like in block 15 and 19, can also be saved inside the user information database 12 for later usage.

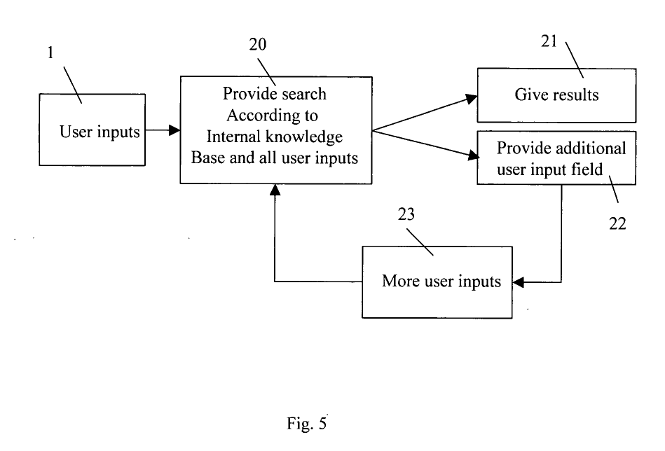

FIG. 5 illustrates an intelligent search engine or service site. After user inputs 1, the engine or site provide search according to internal knowledge base and user inputs in block 20. Then it gives out the results to the user in block 21, in the same time it also provides an additional user input field in block 22 for the user to narrow down the search. After user gives more inputs in block 23, it can go back to the loop in block 20, until the user gets satisfied results.

We claim:

1. Search engine, website, or other service which comprises,
a. A user input interface
b. A service output interface
c. A resource database storing the searchable information;
d. An intelligent analyzer analyzing the scope and completeness of the user input

2. Service defined in claim 1 is an online store, online search engine, company website, organization website, online blog site, and other online service site.

3. The service defined in claim 1 is provided by a TV, or a remote controller, or a computer, or a telephone, or a wireless phone, or an automobile control and/or navigation system, or an game module like X-box, play station, or a home entertainment center, or any other programmable chip controlled devices.

4. Service services defined in claim 2 offers greetings and/or small talks to start the services.

5. Service defined in claim 1 analyzes the category, field, or sub-field the user intended in the user input and ask clarification questions to narrow down the selections.

6. The question offering format defined in claim 5 can be text, picture, audio, or video type.

7. Service defined in claim 1 analyzes the category, field, or sub-field the user intended in the user input and give multiple choices/suggestions for the user to narrow down the selection.

8. Service defined in claim 1 provides the most relevant results to the user input while providing another input field for the user to further narrow down the inquiry.

9. Service defined in claim 1 asks more questions when it see fit to best serve the user.

10. Service defined in claim 1 performs the question/answer process through an interactive character, like a cartoon character, a web pet, or any animation figure.

11. An online website or online store service which comprises,
a. User input interface
b. Service output interface
c. Resource database storing the searchable information;
d. Intelligent analyzer analyzing the scope and completeness of the user input
e. Question generator to generate questions or selections based on the user's input to further narrow down the user's intention.

12. Online services defined in claim 11 offer greetings and/or small talks to start the services.

13. The website or online store defined in claim 11 asks the user questions and collect answers from user to best guide the user.

14. The website or online store defined in claim 11 use the obtained knowledge in the greeting, small talk, and/or questions/answering session to lead the user to the user's desired destination directly without having to go through many clicks.

15. The website or online store defined in claim 11 is provided by a virtual guide, or help, or through a character, like a pin, a cartoon character, a virtual pet, or other animation characters.

16. The website or online store defined in claim 11 provide a brief tour for the user, introducing the most important links on the page, with no click, or on a single click on a specific button/pattern, or on a double click.

17. The website or online store defined in claim 11 provide a detailed tour for the user, introducing the most important links on the page, with no click, or on a single click on a specific button/pattern, or on a double click.

18. The website or online store defined in claim 11 show a video or audio clips for the user as at least part of the tour.

19. Search engine, website, or other online service which comprises,
a. User input interface
b. Service output interface
c. A resource database storing the searchable information;
d. A user database comprising of a user' or many users' special requirements or preferences.

20. The user database defined in claim 19 collect the user's basic information and interaction behaviors in the beginning or periodically.

21. The services defined in claim 19 ask questions to narrow down the user's intention based on the user's input, the user's answers to the previous question(s), and the user database.

22. The user database defined in claim 19 can be stored in local machine or in remote center office.

23. The services defined in claim 19 list its end results in such an order that giving priority to those that the user accessed in the past behavior or according to the user's preference.
